(19) United States
(12) Patent Application Publication
(10) Pub. No.: US 2015/0252149 A1
(43) Pub. Date: Sep. 10, 2015

(54) PREPARATION OF HIGH MOLECULAR WEIGHT, FUNCTIONALIZED POLY(METH) ACRYLAMIDE POLYMERS BY TRANSAMIDATION

(71) Applicants: Chunming ZHANG, Midland, MI (US); Nanrong CHIOU, Midland, MI (US); Sayeed ABBAS, Pearland, TX (US); Xiao Hua QIU, Midland, MI (US); Michael D. READ, Midland, MI (US); Aaron W. SANDERS, Missouri City, TX (US); DOW GLOBAL TECHNOLOGIES LLC, Midland, MI (US)

(72) Inventors: Chunming Zhang, Midland, MI (US); Nan-Rong Chiou, Midland, MI (US); Sayeed Abbas, Pearland, TX (US); XiaoHua S. Qiu, Midland, MI (US); Michael D, Read, Midland, MI (US); Aaron W. Sanders, Missouri City, TX (US)

(21) Appl. No.: 14/427,803

(22) PCT Filed: Sep. 19, 2013
(86) PCT No.: PCT/US2013/060535

§ 371 Date: Mar. 12, 2015

Related U.S. Application Data
(60) Provisional application No. 61/702,963, filed on Sep. 19, 2012.

(51) Int. Cl. C08J 3/18

(52) U.S. Cl. CPC C08J 3/18; C08J 2333/26

(57) ABSTRACT

The present invention provides processes for making higher molecular weight, functionalized poly(meth)acrylamide polymer products. As an overview, the processes use (trans)amidation techniques in the melt phase to react one or more high molecular weight amide functional polymers or copolymers with at least one co-reactive species comprising at least one labile amine moiety and at least one additional functionality other than amine functionality. In practical effect, the processes of the present invention thus incorporate one or more additional functionalities onto an already formed or partially formed polymer rather than trying to incorporate all functionality via copolymerization techniques as the polymer is formed from constituent monomers. The methods provide an easy way to provide functionalized, high molecular weight poly(meth)acrylamide polymer products.

### FIELD OF THE INVENTION

The present invention relates to methods of making high molecular weight, functionalized poly(meth)acrylamide polymers. More particularly, the present invention relates to methods in which high molecular weight, functionalized poly(meth)acrylamide polymers are prepared by (trans)amidation of a high molecular weight (meth)acrylamide polymer with at least one amine functional reactant bearing at least one additional functionality other than amine functionality via melt phase reaction, to convert at least a portion of the amide functionality on the polymer to one or more other kinds of amide functionality. Optionally, the poly(meth)acrylamide polymer may be partially hydrolyzed before the reaction, during the reaction in parallel with (trans)amidation, and/or after the (trans)amidation reaction.

### BACKGROUND OF THE INVENTION

High molecular weight poly(meth)acrylamide polymers and copolymers (collectively polymer products) are widely used in many areas of industry. For instance, these polymer products are widely used in oil fields for enhanced oil recovery. These products also may be used in other oil field applications, including uses as a flocculant, water thickening for enhanced oil recovery, polymer flooding, water clarification, cement thickening and viscosity stabilization, drag reducing agents, flocculation agents, combinations of these and the like. Poly(meth)acrylamide products also are used as coatings and/or are otherwise incorporated into reverse osmosis membranes. The products can be incorporated into other industrial and residential primers, paints, varnishes, and other coatings. In horticulture applications, the polymer products can be used as a growing medium additive such as to help prevent water loss from the growing media. Polyacrylamide products are also used as superabsorbents in sanitary goods, hygienic goods.

The term (meth)acryl with respect to monomers, oligomers, and polymers means methacryl and/or acryl. For example, the term poly(meth)acrylamide polymers refers to polymers obtained by polymerizing methacrylamide and/or acrylamide monomers. The term poly(meth)acrylamide copolymers refers to copolymers obtained by copolymerizing methacrylamide and/or acrylamide monomers with at least one additional copolymerizable reactant such as one or more monomers or oligomers.

As used herein, high molecular weight with respect to poly(meth)acrylamide polymer products means that the polymer products have a number average molecular weight that is high enough such that sufficiently high such that the polymer is a solid at 25° C. at a pressure of 1 atm at a relative humidity of 10% or less. In illustrative modes of practice, the polymer has a molecular weight of at least 50,000, even at least 100,000 preferably at least 250,000, more preferably at least 500,000, and even more preferably at least 1,000,000. In many modes of practice, the number average molecular weight is less than about 50,000,000, preferably less than 35,000,000, more preferably less than 25,000,000. Poly(meth)acrylamide polymer products with higher molecular weights generally are more effective at thickening, flocculation, drag reduction, superabsorbency, combinations of these and the like.

In some applications, poly(meth)acrylamide polymer products are obtained by polymerizing methacrylamide and/or acrylamide. The resultant polymer products have pendant amide functionality. In other applications, poly(meth)acrylamide polymer products include amide functionality and at least one other kind of functionality. Examples of such other functionality include sulfonate, acid, phosphonate, hydroxyl, ether, ester, quarternary amino, epoxy, carboxylic acid, combinations of these and the like. Poly(meth)acrylamide polymer products that incorporate not only amide functionality but also one or more other kinds of functionality which may or may not attach to the polymer via an amide group are referred to herein as functionalized or modified poly(meth)acrylamide polymer products.

Functionalized poly(meth)acrylamide polymer products can be made in different ways. According to a copolymerization approach, functionalized poly(meth)acrylamide polymer products are obtained by copolymerizing (meth)acrylamide monomers with one or more copolymerizable reactants comprising the desired additional functionalities. However, it is generally difficult to obtain copolymers with higher molecular weight using this technique in solution. Due to factors such as the reactivity difference between the different monomers, and chain transfer mechanisms, the molecular weight of the resultant polymer product tends to decrease significantly as the content of the one or more copolymerizable reactants increases.

According to other approaches, functionalized poly(meth)acrylamide polymer products are obtained by first producing a higher molecular weight poly(meth)acrylamide polymer resulting from polymerization of (meth)acrylamide monomer(s). A portion or even all of the pendant amide functionality of the resultant intermediate polymer is then converted into the desired additional functionality. As used herein, functionalized or modified poly(meth)acrylamide polymer products also include polymers in which substantially all of the amide functionality of a poly(meth)acrylamide polymer intermediate is converted into one or more other kinds of functionality, such as carboxylic acid functionality. Unfortunately, many conventional techniques for converting amide into other functionality are costly, complicated, suffer from low yield, are not easily scalable from lab to commercial production, produce undue amounts of by-products, and/or leave undue amounts of unreacted materials. Amidation reactions have been described in U.S. Pat. Nos. 6,277,768 and 5,498,785.

Accordingly, improved techniques for making higher molecular weight, functionalized poly(meth)acrylamide polymer products are needed.

### SUMMARY OF THE INVENTION

The present invention provides processes for making higher molecular weight, functionalized poly(meth)acrylamide polymer products. As an overview, the processes use (trans)amidation techniques in the melt phase to react one or more high molecular weight amide functional polymers or copolymers with at least one co-reactive species comprising at least one labile amine moiety and at least one additional functionality other than amine functionality. In practical effect, the processes of the present invention thus incorporate one or more additional functionalities onto an already formed or partially formed polymer rather than trying to incorporate all functionality via copolymerization techniques as the polymer is formed from constituent monomers. The methods provide an easy way to provide functionalized, high molecular weight poly(meth)acrylamide polymer products.

The terminology (trans)amidation refers to transamidation and/or amidation. The amide functionality in the case of transamidation, and/or carboxylic acid functionality (if any) in the case of amidation, on the polymer reacts in the melt phase with the amine functionality on the co-reactive species to convert the amide functionality and/or carboxylic acid functionality (if any) into one or more other functionalities.

In some illustrative embodiments, the processes accomplish (trans)amidation in the polymer melt phase by reactive extrusion or in equipment capable of high energy mixing of melt phase reactants, such as those commercially available under the trade designations “Haake mixer,” “Haake PolyDrive mixer,” “Haake Polydrive extruder” from Thermo Scientific, and affiliate Thermo Fisher Scientific, Waltham Mass. Consequently, the process is easy to scale up to commercial scale without needing the exorbitant amount of solvent that would be required for reactions carried out only in the solution phase. Using the melt phase also helps to make the processes inexpensive and environmentally friendly. Optionally in combination with ingredients that reduce glass transition temperatures of the polymer reactant(s) such as one or more plasticizers, the processes accomplish (trans)amidation at moderate temperatures to help avoid thermal degradation or decomposition.

In one aspect, the present invention relates to a method of functionalizing an amide functional polymer product, comprising the steps of:
(a) providing an amide functional polymer having a number average molecular weight sufficiently high such that the polymer or copolymer is a solid at 25° C. at a pressure of 1 atm at a relative humidity of 10% or less.
(b) causing the amide functional polymer to be in a melt phase; and
(c) reacting the melt phase amide functional polymer with at least one reactant comprising a labile amine moiety and at least one additional functionality in a manner effective to form a polymer reaction product comprising amide functionality and the at least one additional functionality.

In another aspect, the present invention relates to a method of functionalizing an amide functional polymer product, comprising the steps of:
(a) providing a poly(meth)acrylamide polymer having a number average molecular weight of at least 50,000, said polymer comprising pendant amide functionality;
(b) causing the poly(meth)acrylamide polymer to be in a melt phase; and
(c) reacting the poly(meth)acrylamide polymer with at least one reactant comprising a labile amine moiety and at least one additional functionality in a manner effective to cause an amide functionality of the polymer and the labile amine moiety in the melt phase to form a linkage that functionalizes the poly(meth)acrylamide polymer or copolymer with the at least one additional functionality.

In another aspect, the present invention relates to a method of making an amide functional polymer product having at least one additional functionality, comprising the steps of:
(a) providing an amide functional polymer having a number average molecular weight sufficiently high such that the polymer or copolymer is a solid at 25° C. at a pressure of 1 atm at a relative humidity of 10% or less;
(b) causing the amide functional polymer to be in a melt phase in the presence of a plasticizer; and
(c) reacting the melt phase amide functional polymer with at least one reactant comprising a labile amine moiety and at least one additional functionality under conditions effective to cause a transamidation reaction between the amine moiety and an amide of the polymer.

### BRIEF DESCRIPTION OF THE DRAWINGS

FIG. 1 is a ¹³C-NMR spectra of an embodiment of a functionalized polyacrylamide polymer (“PAM”) prepared in accordance with the present invention.

FIG. 2 is a ¹³C-NMR spectra of an embodiment of a functionalized polyacrylamide polymer prepared in accordance with the present invention.

FIG. 3 is a ¹³C-NMR spectra of an embodiment of a functionalized polyacrylamide polymer (“PAM”) prepared in accordance with the present invention.

FIG. 4 is a ¹³C-NMR spectra of an embodiment of a functionalized polyacrylamide polymer (“PAM”) prepared in accordance with the present invention.

FIG. 5 is a ¹³C-NMR spectra of an embodiment of a functionalized polyacrylamide polymer (“PAM”) prepared in accordance with the present invention.

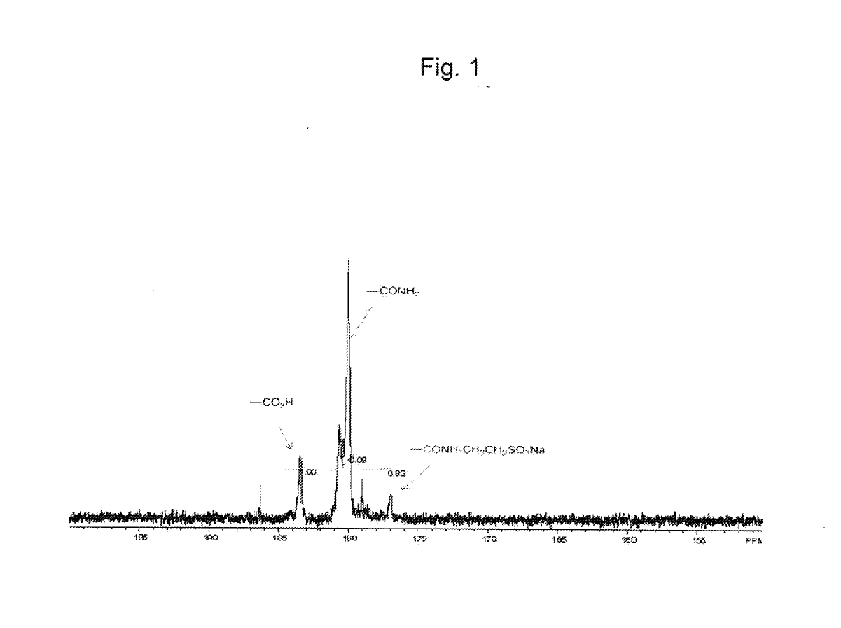

FIG. 1 is a ¹³C-NMR spectra of an embodiment of a functionalized polyacrylamide polymer (“PAM”) prepared in accordance with the present invention.

FIG. 6 schematically illustrates an exemplary transamidation between polyacrylamide and a reactant including a co-reactive amine group and a sulfonate group to prpare a sulfonate functionalized polyacrylamide.

FIG. 7 is a plot of viscosity v. temperature for functionalized functionalized polyacrylamide polymers prepared in accordance with the present invention.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

Amide functional polymers are polymers and/or copolymers that include amide functionality that may be pendant directly from the polymer backbone or may be pendant from side chains that interconnect the amide functionality to the polymer backbone. The pendant amide group(s) may be primary, secondary or tertiary. To enhance conversion of substantially all or a portion of the amide functionality to an alternative functionality, the amide group(s) preferably are primary or secondary. More preferably, the amide group(s) are primary. Primary, secondary, and tertiary amide functionality may be represented by the following formulae, respectively:

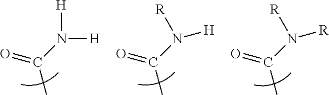

wherein each R is independently H or a monovalent moiety such as a hydrocarbyl group optionally incorporating one or more heteroatoms such as O, S, N, and or P. In the case of a tertiary amide, each R may be a co-member of a ring structure with the other R in some embodiments. Exemplary hydrocarbyl moieties are linear, branched, and/or cyclic aliphatic and/or aromatic, preferably aliphatic moieties comprising only C and H atoms. Desirably, such preferred moieties have 1 to 8, preferably 1 to 4, more preferably one carbon atom. Aliphatic moieties are preferred as these react faster in the (trans)amidation reaction(s) with less risk of thermal degradation.

The amide functional polymer(s) may be linear or nonlinear. Preferred embodiments are substantially linear. In some embodiments, the amide functional polymer(s) may be branched and/or crosslinked such as by forming the amide functional polymer from co-reactive reactant(s) that include at least one monomer ingredient that is polyfunctional with respect to copolymerizable and/or cross-linkable functionality. An example of such a polyfunctional ingredient is N,N-methylene bis(meth)acrylamide. See Polym. Commun., 32(11), 322 (1991); J. Polym. Sci., Part A: Polym. Chem., 30(10), 2121 (1992).

Optionally, the poly(meth)acrylamide polymer may be partially hydrolyzed at the time of the reaction, during the reaction in parallel with (trans)amidation, and/or after the (trans)amidation reaction. Hydrolysis converts amide functionality into carboxylic acid functionality or derivatives thereof such as esters and salts. Thus, partially hydrolyzed poly(meth)acrylamide polymers comprise both amide and carboxylic acid functionality (or derivatives thereof). Carboxylic acid functionality (or derivatives thereof) may be desirable in some modes of practice, as this kind of functionality can enhance solubility or dispersibility in aqueous or other polar media. In other embodiments, it may be desirable to limit or avoid providing hydrolyzed embodiments for the reaction. If partially hydrolyzed polymer embodiments are provided, then it may be desirable in some embodiments that the carboxylic acid functionality or derivatives thereof is limited to 0.001 to 30 mole percent, preferably 0.001 to 10 mole percent, more preferably 0.001 to 1 mole percent based on the total moles of amide and carboxylic acid functionality included in the polymer. In some other embodiments, the polymer as provided has substantially no acid functionality or derivatives thereof.

In the course of carrying out a (trans)amidation reaction, hydrolysis of amide groups on the poly(meth)acrylamide polymer may occur in parallel with (trans)amidation in some modes of practice. Consequently, a poly(meth)acrylamide polymer with no degree of hydrolysis may become partially hydrolyzed as (trans)amidation occurs. In many modes of practice, the amide functional polymer(s) are water soluble. Water soluble means that at least 0.1 gram, preferably at least 0.5 grams, more preferably at least 1.0 grams of the polymer can be dissolved in 100 ml of deionized water at 25° C. This determination is made when the admixture is at equilibrium. In other modes of practice, the amide functional polymer(s) are water dispersible. Water dispersible means that the polymer remains as a separate solid phase which is dispersed in the liquid water phase at 25° C. at equilibrium.

As used herein, the term molecular weight refers to the number average molecular weight unless otherwise noted. In many instances, a material such as a poly(meth)acrylamide may be present as a population distribution in which the actual molecular weight of individual molecules varies within the population. The number average molecular weight provides a statistical way to describe the molecular weight of the population as a weighted average of the actual molecular weights of individual molecules. In other instances, such as for smaller monomers, the material might be present predominantly in a single molecular form (e.g., acrylamide may be present predominantly as

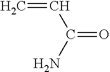

having a molar mass of 71.08 g/mol rather than as a population distribution of different molecules of different sizes). In such instances, the actual molecular weight of individual molecules is substantially identical among the population so that the atomic weight and the number average molecular weight of the population are the same. Hence, the number average molecular weight of acrylamide also is 71.08.

Molecular weight parameters may be determined using any suitable procedures. According to one approach, molecular weight features are determined using size exclusion chromatography.

As used herein, “higher molecular weight” means that a material has a number average molecular weight of at least 100,000, preferably at least 250,000, more preferably at least 500,000, and even more preferably at least 1,000,000. In many modes of practice, the number average molecular weight is less than about 50,000,000, preferably less than 35,000,000, more preferably less than 25,000,000.

One preferred class of amide functional polymers include poly(meth)acrylamide polymer products. As used herein, a poly(meth)acrylamide polymer product is a polymer or copolymer derived from monomer ingredients including (meth)acrylamide and optionally one or more copolymerizable ingredients such as one or more free radically co-polymerizable monomers and/or oligomers. Free radical polymerization is a method of polymerization by which a polymer forms by the successive addition of free radical building blocks. Free radicals can be formed via a number of different mechanisms usually involving separate initiator molecules. Following its generation, the initiating free radical adds repeating units, thereby growing the polymer chain. Free radically polymerized polymer products also are known by a variety of different names, including (meth)acrylic copolymers, vinyl copolymers, acrylic copolymers, free radically polymerized copolymers, and the like.

As used herein, (meth)acrylamide refers to methacrylamide and/or acrylamide monomers. Exemplary (meth)acrylamide monomers may be represented according to the following formula:

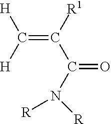

wherein each R independently is as defined above, and R¹ is alkyl (such as methyl) or H. Preferred (meth)acrylamide embodiments include acrylamide

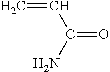

and methacrylamide

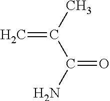

Acrylamide is more preferred.

In some embodiments, the poly(meth)acrylamide polymer products are obtained by copolymerizing one or more (meth)acrylamide monomers with one or more optional copolymerizable reactants such as one or more free radically co-polymerizable monomers or oligomers. Because the molecular weight of the resultant poly(meth)acrylamide tends to be reduced as the amount of co-polymerizable reactant content is increased, it is desirable to limit or even substantially exclude co-polymerizable reactants from the poly(meth)acrylamide polymers during copolymerization. Consequently, it is desirable that the poly(meth)acrylamide includes no more than from 0 to 10, preferably 0 to 5, more preferably 0 to 2, and even 0 weight percent of co-polymerizable reactants based on the total weight of (meth)acrylamide and co-polymerizable reactants (if any). Particularly preferred embodiments of the poly(meth)acrylamide polymer are homopolymers of (meth)acrylamide, more preferably homopolymers of acrylamide, as commercial embodiments of these with higher molecular weights are widely available at low cost from a number of commercial sources.

If any optional co-reactive species are used for copolymerization, these can be selected from a wide variety of one or more free radically co-polymerizable reactants. Preferred embodiments are free radically polymerizable monomers that have molecular weights below about 800, preferably below about 500. The co-polymerizable reactants may be hydrophilic and/or hydrophobic, but preferably are hydrophilic to promote water solubility and/or water dispersibility.

Examples of the co-polymerizable monomers may include one or more alkyl(meth)acrylates, other free radically polymerizable monomers, and the like.

Suitable alkyl(meth)acrylates may be substituted or unsubstituted and include

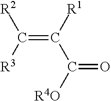

those having the structure:
   wherein R¹ is described as above, R² and R³ independently are hydrogen or methyl, and R⁴ is H or an alkyl group preferably containing one to sixteen carbon atoms and optionally 1 or more hetero atoms such as O, S, P, and/or N. The R⁴ group can be substituted with one or more, and typically 0 to three, moieties such as hydroxy, halo, phenyl, acid, sulfonate, phosphonate, and alkoxyl, for example. The alkyl(meth)acrylate typically is an ester of acrylic or methacrylic acid. Preferably, R¹ is hydrogen or methyl, R² and R³ are hydrogen, and R³ is an alkyl group having one to eight carbon atoms. Most preferably, R¹, R² and R³ are hydrogen and R⁴ is an alkyl group having one to four carbon atoms.

Examples of suitable alkyl(meth)acrylates include, but are not limited to, methyl(meth)acrylate, ethyl(meth)acrylate, propyl(meth)acrylate, isopropyl(meth)acrylate, butyl(meth)acrylate, isobutyl(meth)acrylate, pentyl(meth)acrylate, isoamyl(meth)acrylate, hexyl(meth)acrylate, 2-ethylhexyl(meth)acrylate, cyclohexyl(meth)acrylate, decyl(meth)acrylate, isodecyl(meth)acrylate, benzyl(meth)acrylate, lauryl(meth)acrylate, isobornyl(meth)acrylate, octyl(meth)acrylate, 1-hydroxyethyl(meth)acrylate, 2-hydroxyethyl(meth)acrylate, (meth)acrylic acid, alpha-chloroacrylic acid, alpha-cyanoacrylic acid, beta-methylacrylic acid (crotonic acid), alpha-phenylacrylic acid, beta-acryloxypropionic acid, sorbic acid, alpha-chlorosorbic acid, angelic acid, cinnamic acid, p-chlorocinnamic acid, beta-stearylacrylic acid, itaconic acid, citraconic acid, mesaconic acid, glutaconic acid, aconitic acid, tricarboxyethylene, glycidyl(meth)acrylate, mono- and di-glycidyl itaconate, mono- and di-glycidyl maleate, and mono- and di-glycidyl formate, octyl(meth)acrylate, iso-octyl(meth)acrylate, nonylphenol ethoxylate(meth)acrylate, isononyl(meth)acrylate, diethylene glycol(meth)acrylate, 2-(2-ethoxyethoxyl)ethyl(meth)acrylate, 2-ethylhexyl(meth)acrylate, lauryl(meth)acrylate, butanediol mono(meth)acrylate, beta-carboxyethyl(meth)acrylate, dodecyl(meth)acrylate, stearyl(meth)acrylate, hydroxy functional polycaprolactone ester(meth)acrylate, hydroxymethyl(meth)acrylate, hydroxypropyl(meth)acrylate, hydroxyisopropyl(meth)acrylate, hydroxybutyl(meth)acrylate, hydroxyisobutyl(meth)acrylate, tetrahydrofurfuryl(meth)acrylate, ethylene urea ethyl(meth)acrylate, 2-sulfoethylene(meth)acrylate, nonyl(meth)acrylate, combinations of these and the like.

Additional examples of free radically polymerizable monomers include styrene, substituted styrene such as methyl styrene, halostyrene, isoprene, diallylphthalate, divinylbenzene, conjugated butadiene, alpha-methylstyrene, vinyl toluene, vinyl naphthalene, N-vinyl-2-pyrrolidone, (meth)acrylamide, (meth)acrylonitrile, acrylamide, vinyl acetate, vinyl propionate, vinyl butyrate, vinyl stearate, isobutoxymethyl(meth)acrylamide, N-substituted(meth)acrylamide, urea ethyl(meth)acrylamide, vinylsulfonic acid, vinylbenzenesulfonic acid, α-(meth)acrylamidomethyl-propanesulfonic acid, vinyl phosphonic acid and/or its ester and mixtures thereof.

The amide functional polymer is further functionalized by converting at least a portion of the pendant amide functionality into one or more additional kinds of functionality. This functionalization occurs in the melt phase. Without wishing to be bound by theory, it is believed that the functionalization occurs via transamidation. In case that the (meth)acrylamide polymer contains carboxylic acid functionality (or derivatives thereof), amidation potentially occurs between the carboxylic group of the polymer and the co-reactive species (amine).

Transamidation is accomplished by reacting at least one high molecular weight amide functional polymer with one or more reactant(s) (hereinafter also referred to as the functionalizing reactant) comprising labile amine functionality and at least one other functionality in the melt phase. The labile amine functionality is reactive with the amide functionality in a manner effective to cause at least one other functionality to become pendant from the amide functional polymer.

FIG. 6 schematically illustrates an exemplary transamidation reaction between polyacrylamide homopolymer 10 and a reactant 14 including a primary amine group 16 and a sulfonate group 18, wherein M may be selected from H or a cation such as Li, K, Na, quaternary ammonium, and combinations of these. The reaction product 20 is a poly(meth)acrylamide polymer in which a portion 22 of the product 20 incorporates pendant sulfonate functionality. Schematically, the reaction reacts amine functionality with the amide functionality to cause the residue of the reactant 14 to be coupled to the polymer backbone of product 20.

This reaction scheme as illustrated in FIG. 1 advantageously incorporates sulfonate functionality onto the already formed poly(meth)acrylamide polymer rather than trying to incorporate sulfonate functionality via copolymerization techniques. FIG. 1 shows the partial 13C-NMR of the reaction product of PAM and 2-amino ethanesulfonic acid sodium salt in the presence of water as a plasticizer. Referring again to FIG. 6, this allows an embodiment of homopolymer 12 to be used that has a higher molecular weight as compared to a conventional reaction in which sulfonate is incorporated into product 20 only via copolymerization. In short, the reaction scheme provides a way to provide high molecular weight poly(meth)acrylamide polymers that are functionalized with amide functionality and at least one other kind of functionality.

In some embodiments, functionality may be incorporated into the poly(meth)acrylamide polymer using both copolymerization and transamidation techniques. For instance, a poly(meth)acrylamide polymer may be provided that is the copolymerized product of acrylamide and acrylic acid, wherein the acrylic acid content is limited so that the poly(meth)acrylamide polymer has a higher molecular weight as defined herein. This initial polymer has acid functionality from the (meth)acrylic acid in addition to the amide functionality. Then, in a transamidation scheme, at least a portion of the amide groups can be reacted with a reactant including a labile amine group and an additional functionality such as sulfonate or the like. The resultant transamidation product would then include amide, acid and sulfonate functionality. It can be appreciated, therefore, that the transamidation strategy of the present invention is an easy way to provide functionalized, high molecular weight poly(meth)acrylamide polymers.

Labile with respect to the amine group of the functionalizing reactant means that the amine group includes at least one hydrogen on the amino nitrogen. The amine groups may be primary (two hydrogens) and/or secondary (one hydrogen). Primary amines are preferred. If secondary amines are used, it is often desirable if the non-hydrogen substituent of the nitrogen is a hydrocarbyl moiety of 8 or less carbon atoms, preferably 1-4 carbon atoms, more preferably 1 to 2 carbon atoms, as such embodiments of secondary amine groups tend to react faster under transamidation conditions than amine groups including larger substituents. In additional embodiments of second amines, cyclic amines, such as morpholine, pyrrolidine, piperidine.

In addition to the labile amine functionality, the reactant includes at least one other functionality to be incorporated into the poly(meth)acrylamide polymer. A wide variety of other functional group(s) may be used. Examples include sulfonate, sulfonic acid, phosphonate, phosphonic acid, hydroxyl, ether, ester, quarternary amino, epoxy, carboxylic acid, pyrrolidone, metal salts of an acid (ionomer), combinations of these and the like. If more than one kind of additional functionality is used, the functionality may be included on the same or on different reactants. For example, reactants comprising labile amine as well as sulfonate and carboxylic acid functionality may be used such as those described in U.S. Pat. No. 4,680,339.

A wide variety of reactants containing at least one labile amine group and at least one additional functionality may be used. Examples include one or more of the amine/acid/sulfonate functional reactants described in U.S. Pat. Nos. 4,680,339, 4,921,903, and 5,075,390, and the like.

In one mode of practice suitable for incorporating sulfonate functionality into a poly(meth)acrylamide polymer, the functionalizing reactant is an amine and sulfonate functional compound of the formula

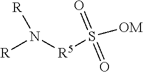

wherein each R is as defined above with the proviso that at least one R is hydrogen, and R³ is a divalent linking group containing 1 to 12, preferably 1 to 8, more preferably 1 to 4 carbon atoms. R⁵ optionally may include 1 or more heteroatoms. Most preferably, R³ is a hydrocarbyl moiety containing 2 to 3 carbon atoms. M may be selected from H or a cation such as Li, K, Na, quaternary ammonium, and combinations of these. Smaller reactants are preferred as these tend to react faster with the poly(meth)acrylamide polymer.

Particularly preferred embodiments of amine and sulfonate functional compounds include the following, wherein each M independently is as defined above:

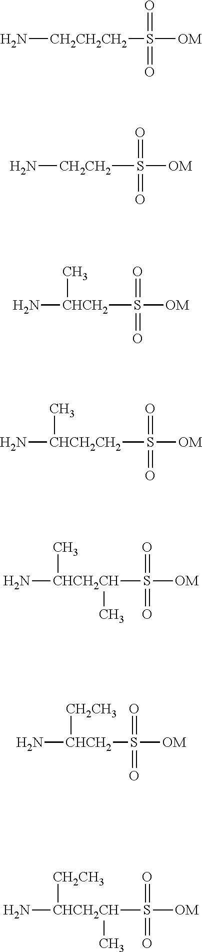

The reaction between the at least one amide functional polymer and the functionalizing reactant occur in the melt phase with respect to the poly(meth)acrylamide polymer. In the melt phase, the two reactants can be thoroughly mixed to allow the desired functionalization reaction to occur with the ingredients in intimate contact. The reactants can be combined before and/or during melt phase reaction, whether or not a melt actually exists at the time of combination.

Specific embodiments of amines suitable in the practice of the invention include one or more of

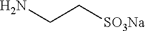

wherein in one illustrative embodiment 85 mol % of a poly(meth)acrylamide polymer with a molecular weight of 5 to 6 million was reacted with 15 mol % of this amine with a plasticizing amount of water at 125° C. to 160° C. for 10 to 20 minutes produced a transamidated product whose 13C-NMR spectra is shown in FIG. 1;

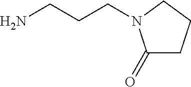

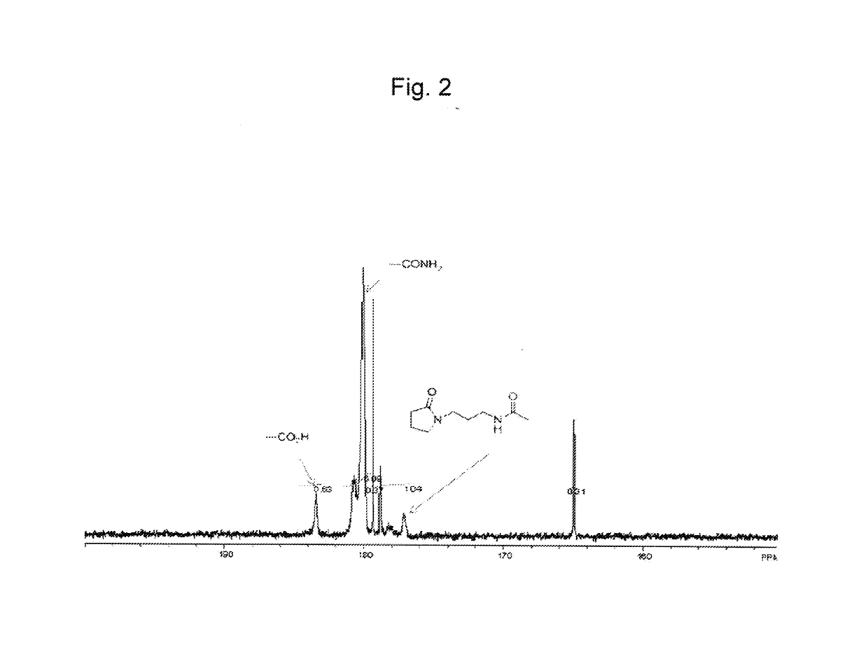

(1-(3-aminopropyl) pyrrolidin-2-one) wherein in one illustrative embodiment 85 mol % of a poly(meth)acrylamide polymer with a molecular weight of 5 to 6 million was reacted with 15 mol % of this amine with a plasticizing amount of water at 125° C. to 160° C. for 10 to 20 minutes produced a transamidated product whose 13C-NMR spectra is shown in FIG. 2;

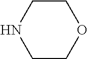

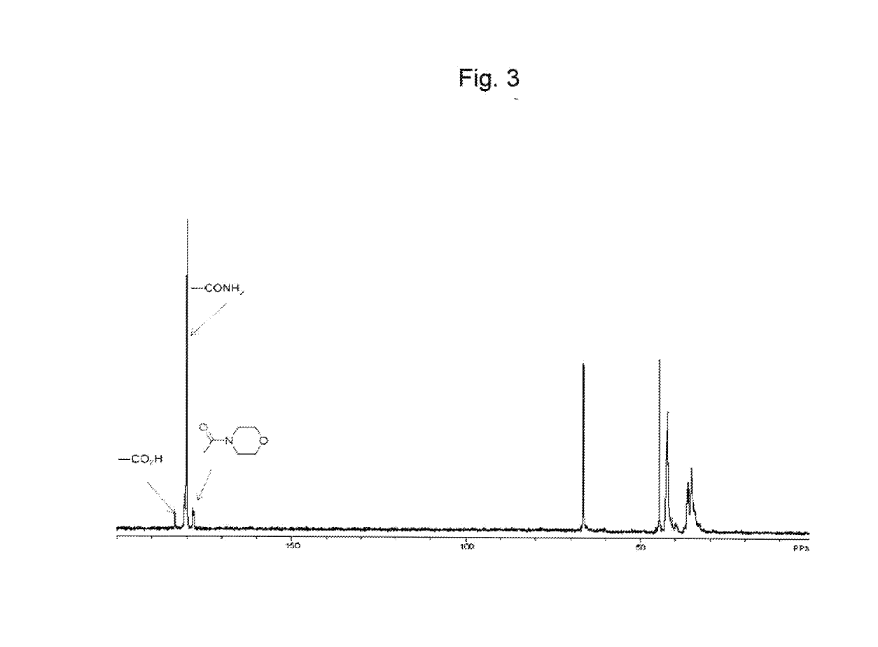

(morpholine) wherein in one illustrative embodiment 85 mol % of a poly(meth)acrylamide polymer with a molecular weight of 5 to 6 million was reacted with 15 mol % of this amine with a plasticizing amount of water at 125° C. to 160° C. for 10 to 20 minutes produced a transamidated product whose 13C-NMR spectra is shown in FIG. 3:

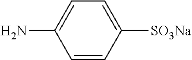

wherein in one illustrative embodiment 85 mol % of a poly(meth)acrylamide polymer with a molecular weight of 5 to 6 million was reacted with 15 mol % of this amine with a plasticizing amount of water at 125° C. to 160° C. for 10 to 20 minutes reacted much more slowly under the transamidation conditions to produce no transamidation such that carrying out the reaction for a longer length of time under these conditions would be needed to obtain conversion via transamidation; and

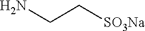

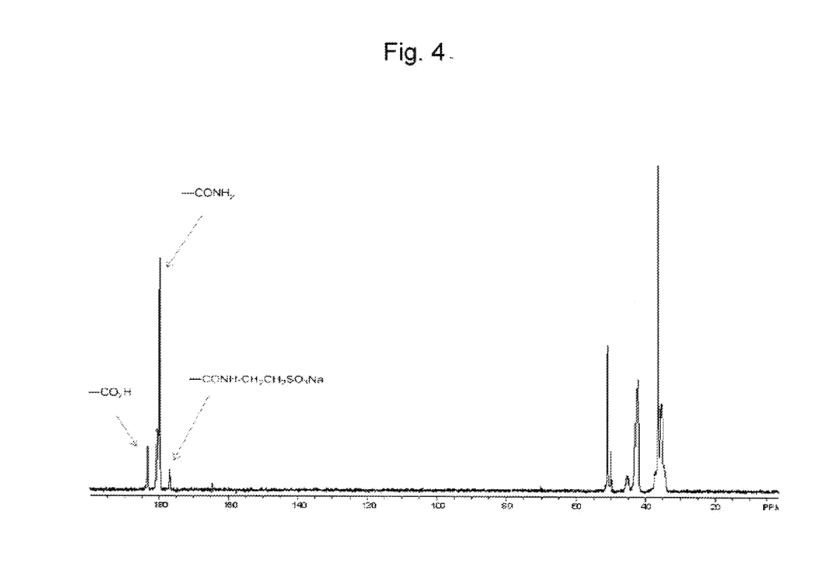

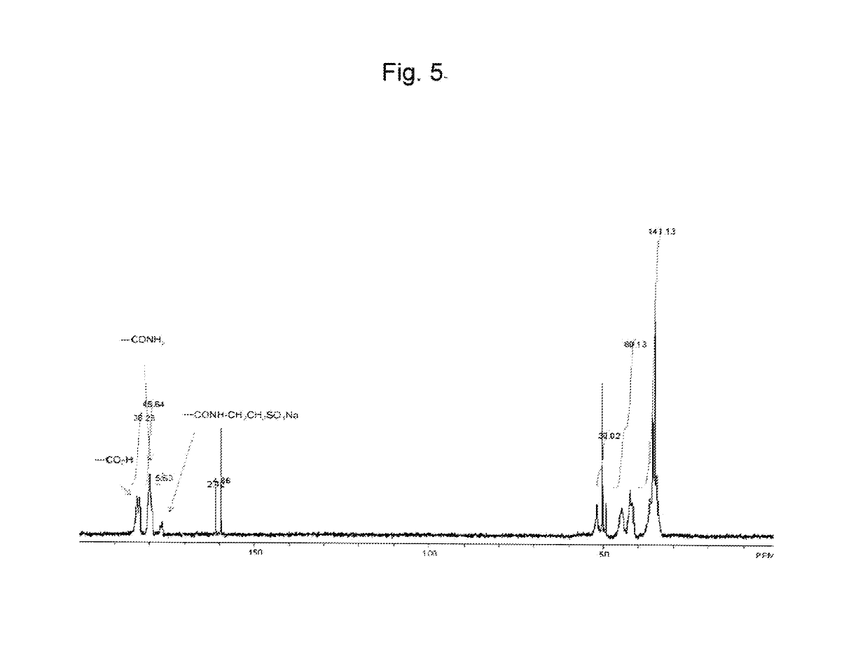

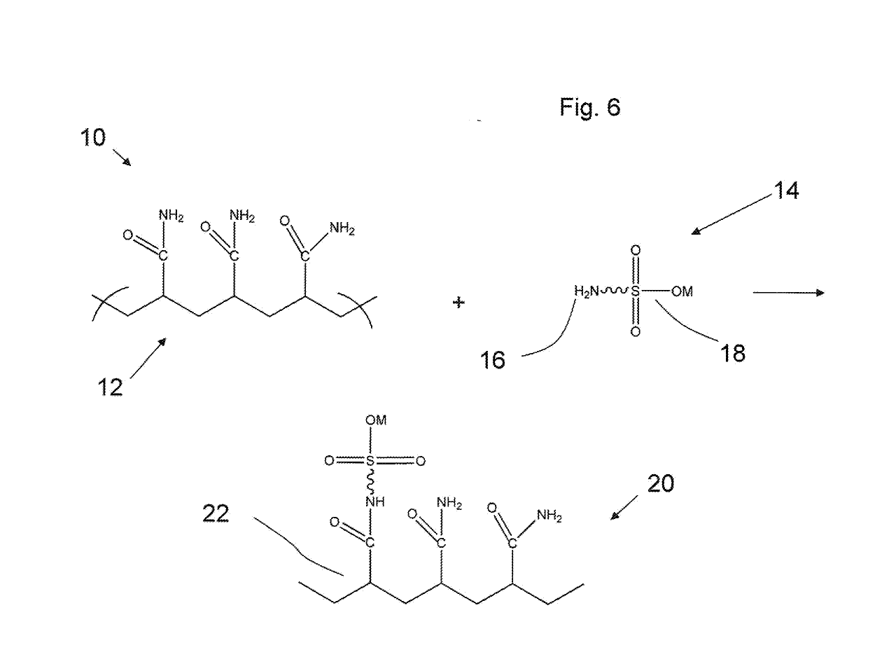

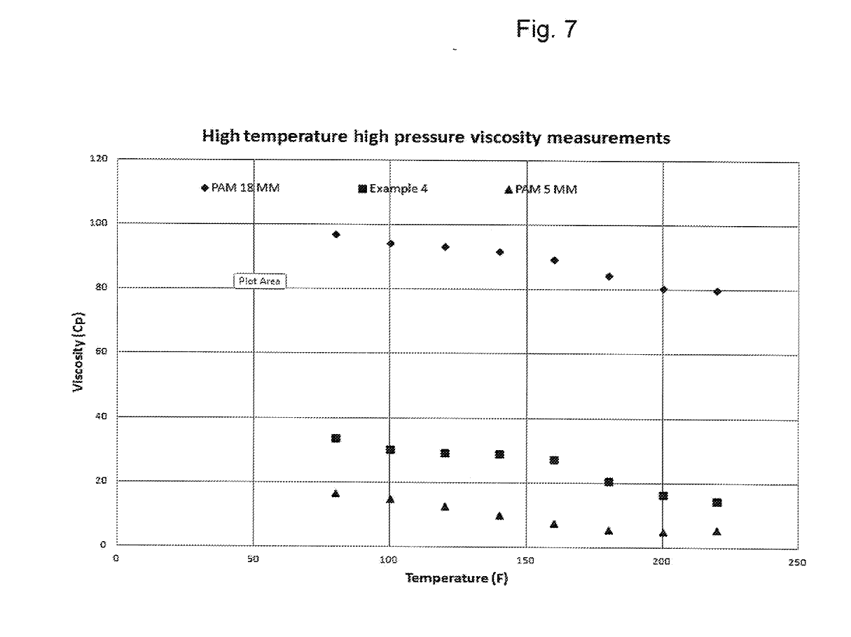

(2-aminoethane sulfonic acid sodium salt) wherein in one illustrative embodiment 85 mol % of a poly(meth)acrylamide polymer with a molecular weight of 18 million was reacted with 15 mol % of this amine (FIG. 4) and 30 mol % of this amine (FIG. 5) with a plasticizing amount of water at 125° C. to 160° C. for 10 to 20 minutes produced a transamidated product whose 13C-NMR spectra are shown in FIGS. 4 and 5, respectively.

Other examples of suitable amines include polyetheramines such as those available under the trade designation JEFFAMINE®. Jeffamine polyetheramines of any series may be used such as the M series. These can be used to impart toughness, flexibility, and other desired characteristics. Such amines have low toxicity and resist discoloration. These also promote compatibility with water or other polar plasticizers.

Melt phase processing means that the reaction occurs under conditions such that the amide functional polymer is in a molten state at or above the glass transition temperature (Tg) of the amide functional polymer. With melt phase processing, the amide functional polymer returns to the solid state at lower temperatures. Melt phase processing is differentiated from solution-based processing in that melt phase processing does not substantially rely on a solvent to achieve a fluid phase. Melt phase processing is therefore more easily scaled up from lab to commercial scales in terms of solvent demand. In some embodiments, plasticizers, e.g., liquid plasticizers and/or solid plasticizers that dissolve in the polymer and/or in the presence of other plasticizer(s), can be included—to reduce the Tg and to facilitate mixing action during the reaction. However, the plasticizer is used in amounts to facilitate plasticizing and is generally present in too small an amount to solubilize the amide functional polymer into a solution phase. For instance, water is an example of a liquid that can be used as a plasticizer in an amount too small to solubilize many poly(meth)acrylamide polymers. If present in a sufficient quantity, water can function as a solvent to create a poly(meth)acrylamide polymer solution. However, due to the higher molecular weight of the poly(meth)acrylamide polymer, the resultant solutions are typically very dilute in order to cause the poly(meth)acrylamide polymer to be in solution.

Use of a plasticizer is quite beneficial. A poly(meth)acrylamide polymer may decompose below the melting temperature of the polymer. For example a poly(meth)acrylamide polymer embodiment may have a melting temperature of 245° C., but unduly decompose at 210° C. or higher. In such instances, a plasticizer may be included to lower the Tg and melting temperature of the resultant admixture to a temperature at which undue decomposition is avoided. For instance, using this same polymer as an example, mixing 100 parts by weight of the polymer with 50 parts by weight of water may reduce the melting temperature to 125° C. or lower, thereby allowing melt phase processing below the decomposition temperature.

For instance, a solution of a higher molecular weight polymer may need to be as dilute as 10 weight percent or less, or even 5 weight percent or less, of the polymer based on the total weight of the polymer and the water to provide a single phase solution. In contrast, when water and poly(meth)acrylamide polymer are combined in more concentrated mixtures, the water plasticizes the polymer but is not present in a sufficient quantity to provide a single phase solution. In representative modes of practice, the melt phase poly(meth)acrylamide polymer is plasticized by water when the weight ratio of the polymer to the water is in the range from 1000:1 to 1:3, preferably 50:1 to 1:1.

Melt phase processing is thus contrasted to solution phase processing in which the amide functional polymer is dissolved in a sufficient quantity of a suitable solvent to achieve a single phase, liquid state. Unlike melt phase processing, solution phase processing is substantially more difficult to scale up. When using higher molecular weight poly(meth)acrylamide polymers, solutions must be very dilute to dissolve the polymer and avoid very high viscosities that would limit the rate of heat and mass transfer of reactants. This means that a substantial amount of solvent is needed to form the dilute solutions. Additionally, a substantial amount of effort is needed to remove so much solvent if the functionalized polymer product is subsequently to be recovered from the solvent. Solution phase processes for higher molecular weight poly(meth)acrylamide polymers are not as practical and are much more expensive overall than melt phase processing.

The melt phase reaction may occur at a wide range of temperatures in which the poly(meth)acrylamide polymer(s) are in a melt phase. If the temperature is too low, though, the reaction may proceed at a slower rate than might be desired to achieve throughput goals. On the other hand, if the temperature is too high, the risk of thermal degradation of the amide functional polymer and/or the functionalizing reactant may unduly increase. Balancing such concerns, the melt phase reaction desirable occurs at a temperature in the range from 50 to 200° C., desirably 80 to 180° C., or even 100 to 150° C.

The melt phase reaction mixture is a relatively viscous admixture. Accordingly, the amide functional polymer and the functionalizing reactant desirably are mixed in equipment capable of handling such viscous mixtures. Exemplary equipment suitable for melt phase mixing of viscous admixtures include single and twin rotor extruders, Haake mixers, Banbury mixers, two roll mills, and the like. Such mixing may cause some chain degradation of amide functional polymer and/or functionalized amide functional polymer to occur. If this happens, the functionalized amide functional polymer product may have a lower number average molecular weight than the starting amide functional polymer reactant. Less chain degradation has been observed using extruders for mixing.

Without wishing to be bound by theory, chain degradation may be observed as a reduction in viscosity of the melt phase admixture. For example, in one experiment, a polyacrylamide homopolymer with a number average molecular weight of 20 million is observed to have an initial viscosity of 97 centipoise at 80° F. and at a pressure of 400 psi. This polymer reactant is modified to have sulfonate functionality in accordance with the present invention by reacting the polymer with a sulfonate functional amine. The reaction occurs in the melt phase while mixing with a high shear mixer capable of handling the relatively viscous admixture. After mixing, a drop in viscosity to 34 centipoise is observed at the same conditions. Without wishing to be bound by theory, it is believed that at least a portion of the viscosity reduction may be due to chain degradation caused by high shear mixing. Yet, the reduced viscosity is still indicative of polymer chains with very high molecular weight, e.g., a number average molecular weight of 1,000,000 or more or even 5,000,000 or more.

The relative amounts of poly(meth)acrylamide polymer and functionalizing reactant may vary over a wide range. Selecting appropriate relative amounts of the reactants will depend on factors such as the amount of amide functionality to be converted to the additional functionality, the molecular weight of the poly(meth)acrylamide polymer, the viscosity of the melt admixture at the reaction temperature, the nature of the functionalizing reactant, the targeted application of the modified polymers, and the degree of conversion. In many representative embodiments, the poly(meth)acrylamide polymer is reacted with a sufficient amount of functionalizing reactant such that the molar ratio of labile amine functionality on the functionalizing reactant(s) to amide functionality on the poly(meth)acrylamide polymer is in the range from 0.01:1000 to 3:1, preferably 0.01:1000 to 1:1, more preferably from 1:1000 to 1:1, or even more preferably from 1:200 to 1:1.

In some modes of practice, the melt phase reaction occurs in a protected atmosphere that is isolated from the ambient, such as in a synthetic atmosphere that is substantially inert with respect to the reactants. Exemplary protective atmospheres include one or more of nitrogen, helium, argon, combinations of these, and the like. In some modes of practice, oxygen is excluded from the reaction atmosphere at least to some degree relative to the oxygen content of the ambient.

The reactants may be mixed in the melt phase for a time period selected over a wide range. In illustrative embodiments, the melt phase admixture is mixed for a time period in the range from 3 seconds to 72 hours, desirably from about 1 minute to 24 hours, more desirably from 1 minute to about 60 minutes. Without wishing to be bound by theory, the reaction may substantially proceed to completion during melt phase mixing. In other modes of practice, the reactants may continue to react subsequently after mixing has stopped and the melt phase is cooling down. In other modes of practice, the reactants may continue to react in the solid phase.

In addition to the amide functional polymer and the functionalizing reactant, the reaction admixture optionally may include one or more additional ingredients. As one option, one or more transamidation catalysts may be incorporated into the admixture in catalytically effective amounts.

As another optional ingredient, the admixture may include at least one plasticizer. At least one plasticizer may be used in order to reduce the effective thermal, glass transition temperature of the polymer. Glass transition temperature (Tg) may be measured using differential scanning calorimetry (DSC) techniques. Examples of plasticizers include water, one or more polyethers, combinations of these, and the like. Water is a preferred plasticizer.

Other optional ingredients include one or more antioxidants, UV stabilizers, processing aids, color concentrates, surfactants, lubricating agents, catalysts, neutralizing agents, fungicides, bactericides, other biocides, antistatic agents, dissolution aids, fillers, reinforcing fibers, and the like

As an option, the functionalized amide functional polymer product may be recovered from the reaction mixture in a variety of different ways if desired. For example, recovery may be accomplished using techniques such as filtration, distillation, drying, centrifugation, decanting, chromatography, combinations of these and the like.

The resultant functionalized amide functional polymer product often will be a polymer comprising amide functionality and one or more additional kinds of functionality obtained via transamidation of a portion of the amide functionality of the original amide functional polymer reactant. For example, an exemplary functionalized amide functional polymer product may be a polymer comprising repeating units of the formulae:

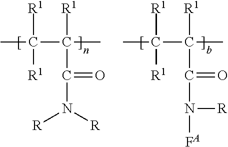

wherein each R, and R¹ independently is as defined above; F^{A} is a moiety that comprises at least one functionality selected from sulfonate, sulfonate, sulfonic acid, acid, phosphonate, phosphonic acid, hydroxyl, ether, ester, quarternary amino, epoxy, carboxylic acid, polyethylene glycol, polypropylene glycol, combinations of these and the like, and b and n are selected so that the ratio of b to n is 0.01:1000 to 3:1, preferably 0.01:1000 to 1:1, more preferably from 1:1000 to 1:1, or even more preferably from 1:200 to 1:5 and such that the polymer has a higher molecular weight in the ranges recited herein. In embodiments in which water is used as at least a portion of the plasticizer, the modified polymers optionally may be partially hydrolyzed to promote compatibility with the water, such as a polymer having repeating units with the following structures

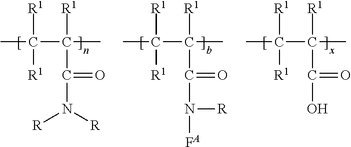

wherein n, b, F^{A}, R, and R¹ are as defined above, and x has a value such that x is 0.001 to 30 percent, preferably 0.001 to 10 percent, more preferably 0.001 to 1 percent of n+b+x.

In a particularly preferred embodiment, a functionalized amide functional polymer product comprises repeating units of the formulae:

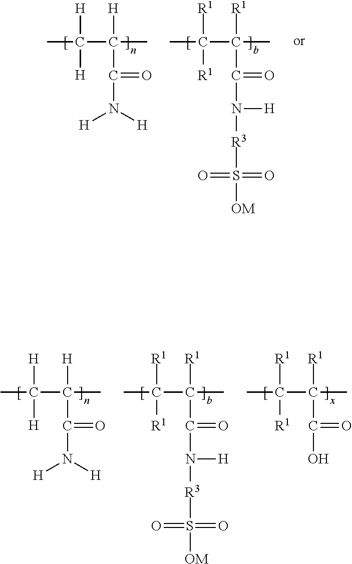

wherein x, n, b, M, R¹, and R³ or as defined above. Preferably, R³ is a divalent hydrocarbyl moiety of 2 to 5, preferably 2 carbon atoms.

The functionalized amide functional polymer products have many uses. For example, the functionalized poly(meth)acrylamide polymer products can be used as coatings on or otherwise incorporated into reverse osmosis membranes. The products can be incorporated into other industrial and residential primers, paints, varnishes, and other coatings. In horticulture applications, the polymer products can be used for growing medium additive. The polymer products also are useful for a wide range of oil field applications, including uses as a flocculant, water thickening for enhanced oil recovery, polymer flooding, water clarification, cement thickening and viscosity stabilization, drag reducing agents, combinations of these and the like.

The present invention will now be further described with reference to the following illustrative examples.

In the following examples, a Haake mixer with an approximately 50-mL mixing chamber is used. The rotation rate is set at 100 rpm and the heater is set at 125° C. or 150° C. The mixing time is set for 10 to 20 minutes. When the machine is ready to run, a mixture of high molecular weight PAM, an amine, and a plasticizer (e.g., water) are slowly added to the Haake mixer to melt and mix for 10 to 20 min. The Haake mixer system is then turned off and is allowed to cool to ambient temperature. The resulting material is collected and may be analyzed by ¹³C-NMR.

### Example 1

### Modification of PAM of Mw 5,000,000-6,000,000 with 15 mol % 2-aminoethanesulfonic Acid Sodium Salt

PAM (Mw 5,000,000-6,000,000, 17.77 g, 250 mmol of CONH₂ group) was mixed with a solution of 2-aminoetanesulfonic acid sodium salt (37.5 mmol, prepared by mixing 2-aminoethanesulfonic acid 4.7 g, 37.5 mmol, sodium hydroxide 1.5 g, 37.5 mmol, and water 17.77 g) at ambient temperature. The resulting mixture was added to the Haake mixer and was processed at 125° C. to 160° C. for 14 min at 100 rpm. After cooling, the resulting material was collected (20.1 g). Analysis of the material by ¹³C-NMR showed a new amide group from transamidation of PAM with the 2-aminoethanesulfonic acid sodium salt (FIG. 1).

### Example 2

### Modification of PAM of Mw 5,000,000-6,000,000 with 15 mol % 1-(3-aminopropyl)pyrrolidin-2-one

PAM (Mw 5,000,000-6,000,000, 12.5 g, 175.8 mmol of CONH₂ group) was mixed with 1-(3-aminopropyl)pyrrolidin-2-one (3.75 g, 26.4 mmol) and water (12.5 g). The resulting mixture was added to the Haake mixer and was processed at 150° C. to 160° C. for 10 min at 100 rpm. After cooling, the resulting material was collected (14.1 g). Analysis of the material by ¹³C-NMR showed a new amide group from transamidation of PAM with 1-(3-aminopropyl)pyrrolidin-2-one (FIG. 2).

### Example 3

### Modification of PAM of Mw 5,000,000-6,000,000 with 15 mol % Morpholine

PAM (Mw 5,000,000-6,000,000, 17.77 g, 250 mmol of CONH₂ group) was mixed with morpholine (6.54 g, 75 mmol) and water (17.77 g) at ambient temperature. The resulting mixture was added to the Haake mixer and was processed at 125° C. to 160° C. for 14 min at 100 rpm. After cooling, the resulting material was collected. Analysis of the material by ¹³C-NMR showed a new amide group from transamidation of PAM with the morpholine (FIG. 3).

### Example 4

### Modification of PAM of 18,000,000 with 15 mol % of 2-aminoethanesulfonic Acid Sodium Salt

PAM (Mw 18,000,000, 17.77 g, 250 mmol of CONH₂ group) was mixed with a solution of 2-aminoethanesulfonic acid sodium salt (37.5 mmol, prepared by mixing 2-aminoethanesulfonic acid 4.7 g, 37.5 mmol, sodium hydroxide 1.5 g, 37.5 mmol, and water 17.77 g) at ambient temperature. The resulting mixture was added to the Haake mixer and was processed at 125° C. to 160° C. for 20 min at 100 rpm. After cooling, the resulting material was collected (20.1 g). Analysis of the material by ¹³C-NMR showed a new amide group from transamidation of PAM with the 2-aminoethanesulfonic acid sodium salt (FIG. 4).

### Example 5

### Modification of PAM of 18,000,000 with 30 mol % of 2-aminoethanesulfonic Acid Sodium Salt

PAM (MW 18,000,000, 17.77 g, 250 mmol of CONH₂ group) was mixed with a solution of 2-aminoetanesulfonic acid sodium salt in water (75 mmol, prepared b_{y} mixing 2-aminoethanesulfonic acid 9.4 g, 75 mmol and sodium hydroxide 3.0 g, 75 mmol in water 17.77 g) at ambient temperature. The resulting mixture was added to the Haake mixer and was processed at 125° C. to 160° C. for 14 min at 100 rpm. After cooling, the resulting material was collected. Analysis of the material by ¹³C-NMR showed a new amide group from transamidation of PAM with the 2-aminoethanesulfonic acid sodium salt (FIG. 5).

### Example 6

Viscosities of polymer solutions containing the functionalized polymers prepared in Examples 4 and PAM with molecular weights of 5,000,000-6,000,000 and 18,000,000, respectively, were measured in a Grace Instrument M5600 viscometer. The instrument is a coquette, coaxial, cylindrical high pressure and temperature rheometer with maximum pressure rating of 1000 psi. A B5 bob with a radius of 1.5987 cm and effective length of 7.62 cm was used. The polymers solution was kept under a pressure of approximately 400 psi (applied by high pressure nitrogen source) during the experiments to keep water from boiling. Approximately 52 ml of polymer solution was placed in the cup. Temperature was varied from 80° F. to 220° F. in increments of 20° F. At each temperature the solution was aged for 5 minutes at a shear rate of 20 sec⁻¹ after which a reading was taken at a shear rate of 150 and 200 sec⁻¹ for 2 minutes. The viscosity measured at a shear rate of 200 sec⁻¹ is reported in FIG. 7. The pressure variation during the temperature ramp was negligible compared to the pre-applied pressure of 400 psi at the start of the experiment. The data shows a reduction in viscosity of the original poly(meth)acrylamide polymer (PAM) with a molecular weight of 18,000,000 Da. Chain degradation might be one of the causes contributing to the reduction in viscosity. The figure also shows viscosity measurements for a PAM with a molecular weight of 5,000,000 Da. We observe that the viscosity of the modified polymer in Example 5 is higher than the unmodified PAM polymer with a molecular weight of 5,000,000 Da. One can infer from this result that the molecular weight of the modified polymer in Example 5 is higher than 5,000,000 Da and the post-modification process disclosed herein is capable of producing functionalized high molecular weight poly(meth)acrylamides.

1. A method of functionalizing an amide functional polymer product, comprising the steps of:
(a) providing an amide functional polymer having amide functionality and a number average molecular weight sufficiently high such that the polymer is a solid at 25° C. at a pressure of 1 atm at a relative humidity of 10% or less.
(b) causing the amide functional polymer to be in a melt phase, wherein the melt phase further comprises a plasticizer present in an amount that does not solubilize the amide functional polymer into a solution phase; and
(c) in the presence of the plasticizer, reacting the melt phase amide functional polymer with at least one reactant comprising a labile amine moiety and at least one additional functionality in a manner effective to form a polymer reaction product comprising amide functionality and the at least one additional functionality.

2-4. (canceled)

5. The method of claim 1, wherein the amide functional polymer provided in step (a) is partially hydrolyzed.

6. The method of claim 1, wherein the reaction product further comprises carboxylic acid functionality or a derivative thereof.

7. (canceled)

8. The method of claim 1, wherein the amide functional polymer provided in step (a) has a number average molecular weight in the range from at least 500,000 to less than about 25,000,000.

9. The method of claim 1, wherein step (c) comprises a transamidation reaction.

10. The method of claim 1, wherein the polymer provided in step (a) comprises a poly(meth)acrylamide polymer.

11. (canceled)

12. The method of claim 1, wherein the polymer provided in step (a) is derived from reactants comprising (meth)acrylamide and from 0 to 2 weight percent of one or more copolymerizable reactants based on the total weight of the (meth)acrylamide and co-polymerizable reactants.

13. (canceled)

14. The method of claim 12, wherein the one or more copolymerizable reactants comprise an alkyl(meth)acrylate.

15. The method of claim 12, wherein the one or more copolymerizable reactants comprise styrene, substituted styrene, and mixtures thereof.

16. (canceled)

17. (canceled)

18. The method of claim 1, wherein the at least one additional functionality comprises sulfonate.

19. The method of claim 1, wherein the at least one reactant of step (c) comprises a compound of the formula 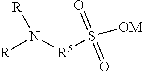
wherein each R is selected from H and a hydrocarbyl of 8 or less carbon atoms with the proviso that at least one R is hydrogen; R⁵ is a divalent linking group containing 1 to 12 carbon atom; and M is selected from H, a cation, and combinations of these.

20. The method of claim 19, wherein the at least one reactant of step (c) comprises a compound of the formula

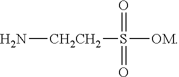

21. The method of claim 1, wherein the at least one reactant of step (c) comprises a compound of the formula

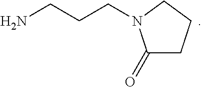

22. The method of claim 1, wherein the at least one reactant of step (c) comprises a compound of the formula

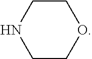

23. The method of claim 1, wherein the at least one reactant of step (c) comprises a compound of the formula

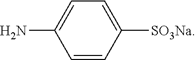

24. The method of claim 1, wherein the at least one reactant of step (c) comprises a polyetheramine.

26. The method of claim 1, wherein the amide functional polymer comprises a poly(meth)acrylamide polymer and the weight ratio of the poly(meth)acrylamide polymer to the plasticizer is in the range from 50:1 to 1:1.

27. The method of claim 1, wherein the plasticizer comprises water.

28. The method of claim 1, wherein the functionalized amide functional polymer product prepared in step (c) comprises repeating units of the formulae: 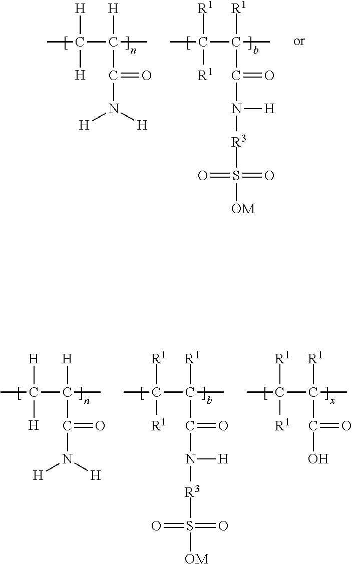
wherein each R¹ independently is alkyl or H; R³ is a divalent hydrocarbon moiety of 2-5 carbon atoms; M is H or a cation, and b and n are selected so that the ratio of b to n is 0.01:1000 to 3:1 and such that the polymer has a number average molecular weight of at least 100,000; and x is 0.001 to 30 percent of n+b+x.

29. (canceled)

30. (canceled)
